(19) United States
(12) Patent Application Publication
(10) Pub. No.: US 2022/0289148 A1
(43) Pub. Date: Sep. 15, 2022

(54) Vehicle Cleaning System

(71) Applicants: William Michel, Sarasota, FL (US); Diana Michel, Sarasota, FL (US)

(72) Inventors: William Michel, Sarasota, FL (US); Diana Michel, Sarasota, FL (US)

(21) Appl. No.: 17/130,251

(22) Filed: Dec. 22, 2020

(51) Int. Cl. B60S 1/66; B05B 12/14; B05B 1/20; B05B 15/60; B08B 3/02

(52) U.S. Cl. CPC B60S 1/66; B05B 12/14; B05B 1/20; B05B 15/60; B08B 3/02

(57) ABSTRACT

A vehicle cleaning system that can be manufactured to integrate with an existing motor vehicle or as part of a new vehicle manufacture, providing a convenient automated method of cleaning a large motor vehicle such as a trailer or RV. The vehicle cleaning system can be implemented by delivering water from either an independent valve running to an onboard cleaning system; a water line connection; or from an onboard holding tank which may contain water or other cleaning agents, to a valve system operating a series of extrusion nozzles. The cleaning system may have one or more manual or electromechanical pumps and a manual or electromechanical valve system to actuate at least one cleaning cycle, or to activate the operation of the vehicle cleaning system in specific zones along the body of a vehicle. The vehicle cleaning system may operate by means of a roof-mounted actuated piping and nozzle system or an extrusion nozzle spray system having recessed extendable nozzles, or an integrated nozzle system.

### FIELD OF INVENTION

The present invention relates to the field of motor vehicles and accessories, specifically to a vehicle cleaning system for recreational vehicles (“RVs”), semi-trailers and semi-trucks.

### BACKGROUND OF THE INVENTION

Cleaning a large vehicle such as a RV is not as easy as a sedan or common two-axle pickup truck. Various methods to wash and clean dirt and grime from RVs and trailers exist and commonly known. Some include pressure washers, brush attachments to hoses, hand sponges and brushes. Any of these methods present a messy and labor-intensive process. Factors considered in all the various cleaning methods include the size of the vehicle, the water and detergents used. Attempts have been made to automate cleaning of automobiles in general as in the Self-Contained Cleaning System for Motor Vehicles to Wei, U.S. Pat. No. 5,100,058; the System and Apparatus for Automatic Built-In Vehicle Washing to Ahmad, U.S. Pub. 2011/0155192; the Vehicle Headlight Washer System to Pollock, U.S. Pat. No. 3,117,727; and the Boat/RV Mounted Pressure-Wash System to Attar, U.S. Pub. No. 2005/0156060.

The present invention addresses a long felt need in the art by presenting a vehicle cleaning system that can be integrated into the vehicle—a RV for example—and provide a convenient automated method of cleaning a large kicking tee capable of a greater degree of placement angles, improved performance, versatility and safety, making the present invention unique, useful, and highly marketable over all prior art in the field.

A first object of the invention is to provide a system to introduce water or cleaning solutions to easily and effectively clean recreational vehicles, semi-trailers, and other large vehicles that are otherwise difficult to clean due to their size and height.

A second object of the invention is to provide a system of easily and conveniently cleaning large vehicles where access to water and manpower for cleaning said vehicles is limited.

A third object of the invention is to provide an appropriated pressurizes delivery of water or other cleaning agents to a large vehicle to aid in the convenient and effective cleaning of said vehicle, cutting down on time and effort required.

The present invention fulfills the above and other objects by providing a cleaning system for large vehicles that can either be incorporated into new vehicle manufacture, or be retrofitted to existing large vehicles, the preferred embodiment of which comprises a series of nozzles mounted on a body of a large vehicle spaced at lengths along the vehicle defining specific zones for cleaning through which water and various cleaning agents can be introduced, either manually or via electromechanical means, in order to easily and conveniently clean the body of a large vehicle. Other embodiments contemplated by the present invention include means for introducing water spray along the body of the vehicle via either a nozzle or method of connecting the system to an independent water hose line, and a valve system for either manual or automated implementation of at least one cleaning cycles.

The above and other objects, features and advantages of the present invention should become more readily apparent to those skilled in the art upon a reading of the following detailed description in conjunction with the drawings, wherein there is shown and described illustrative embodiments of the invention.

### BRIEF DESCRIPTION OF THE DRAWINGS

In the following detailed description, reference will be made to the attached drawings in which:

FIG. 1 is the preferred embodiment of a roof-mounted actuated piping system as disclosed by the present invention for retrofitting existing vehicles.

FIG. 2 shows a second preferred embodiment of the present invention for a side mounted recessed spray system for new vehicle manufacture.

FIG. 3 shows another embodiment of the present invention for a side mounted extrusion spray system for new vehicle manufacture.

FIG. 4 shows a close up of an embodiment of the invention having recessed nozzles with spray heads mounted at intervals alongside the body of a vehicle.

FIG. 5 shows another embodiment of the invention having and extrusion profile with integrated nozzles.

### DESCRIPTION OF THE PREFERRED EMBODIMENTS OF THE INVENTION

It should be noted that in all the disclosed embodiments of the invention, various permutations of connection means for introducing water or various cleaning agents are possible. Water can be introduced into the vehicle cleaning system by various means, for example, a hose valve or similar valve located independently and running to an onboard cleaning system, a hose line connection or from an onboard holding tank which may contain water or other cleaning agents.

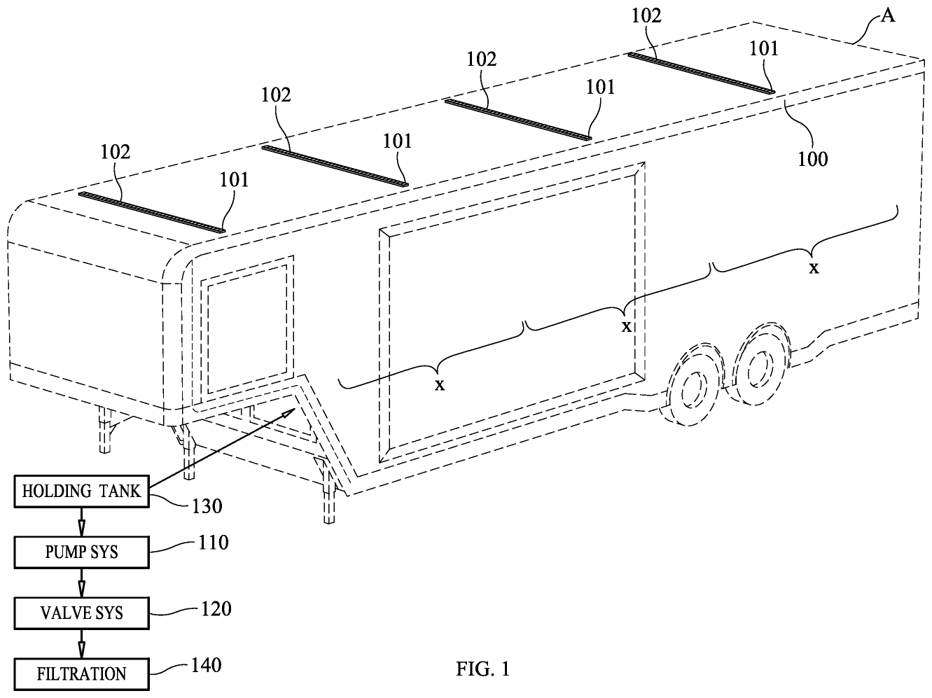

The water connection may further have a manual or an electromechanical pump (FIGS. 1, 2, 3; 110) to create added pressure in delivering cleaning agents to the system. A manual or automated valve system (FIGS. 1, 2, 3; 120) can actuate at least one cleaning cycle contemplated. The valve system (FIGS. 1, 2, 3; 120) can be part of an onboard vehicle cleaning system or part of an independent off board solution. By operating valves, either manually or by electromechanical means, various cleaning cycles can be activated or deactivated. Further, the valves can be configured to operate specific zones (x) along the body of a vehicle (B) and not others to give the user control over the areas to be cleaned.

Delivery of water or cleaning agents may be accomplished by standard water pressure and volume vis-a-vis a typical water spigot (waterline connection) or can be amplified by a high-pressure electromechanical water pump (FIGS. 1, 2, 3; 110). Alternatively, the vehicle may have an onboard holding tank (130) for water or cleaning agents; or the holding tank can be an independent system apart from the vehicle. In either method, the holding tank has connection means to the cleaning system (not shown). The holding tank, containing water, may allow for cleaning agents in tablet or droplet form to be added. Introduction of said cleaning agents may comprise a further cleaning cycle within the vehicle cleaning process. A filtration system (FIGS. 1, 2, 3; 140) may also be implemented as part of the cleaning system.

In either the waterline connection or mechanical pump variations of the cleaning system, the cleaning system can further be connected to a valve system (120) for activating and deactivating at least one definable cleaning cycle. The valve system (120) can be activated manually—by physically turning or switching various valves (not shown) on or off to activate various stages of cleaning—or by an automated means that may allow for a range of cleaning cycles. An automated valve system (120) can be designed to incorporate an automated a switching system or be activated remotely through a software application having Wi-Fi or other NFC means (150) of communication to deliver commands to the cleaning system.

The first embodiment of the invention as shown in FIG. 1 is a roof-mounted actuated piping and nozzle system for aftermarket application for pre-existing vehicles (100), whereby said piping and nozzle system is mounted onto the vehicle. Using a series of nozzles (101) positioned along the body of the vehicle (B), the piping system is capable of delivering the appropriate amount of water flow or chemical cleaning agents to the vehicle, either along the entire body or in specified zones (x) along the body of a vehicle to optimize water pressure and cleaning effectiveness. The cleaning agents contemplated to be used in this invention are similar to those found in car washes and are well known in the art.

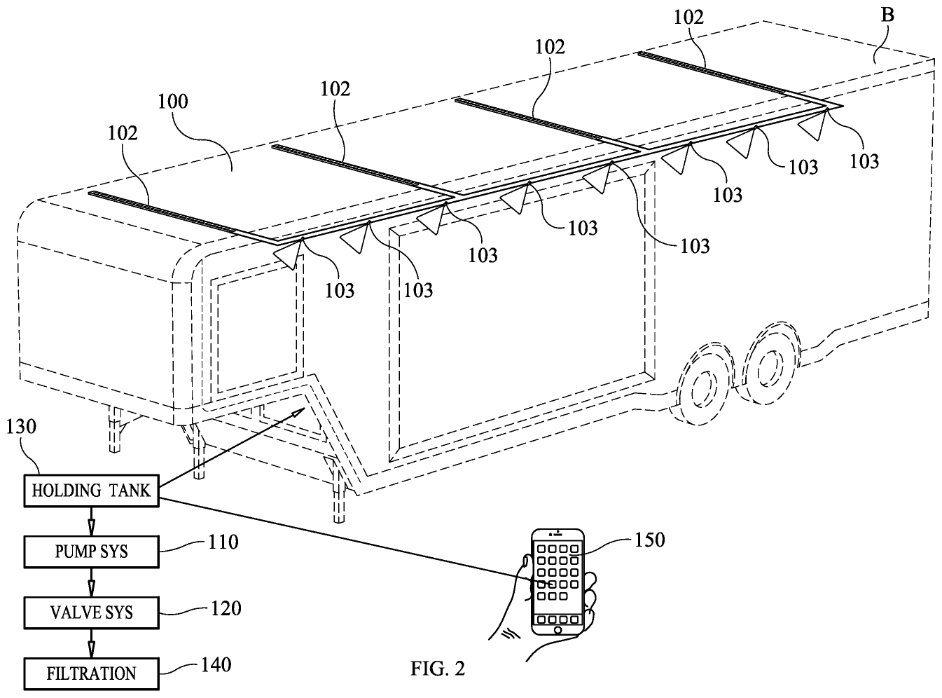

The preferred embodiment of FIG. 2 includes all the features of the embodiment of FIG. 1, with the additional capability of having recessed, extendable nozzles (102), making this embodiment possibly more appropriate for newly constructed vehicles. The spray heads (103) of the nozzles may be static or have rotary actuation to target areas within a specific cleaning zone (x) along the vehicle's body.

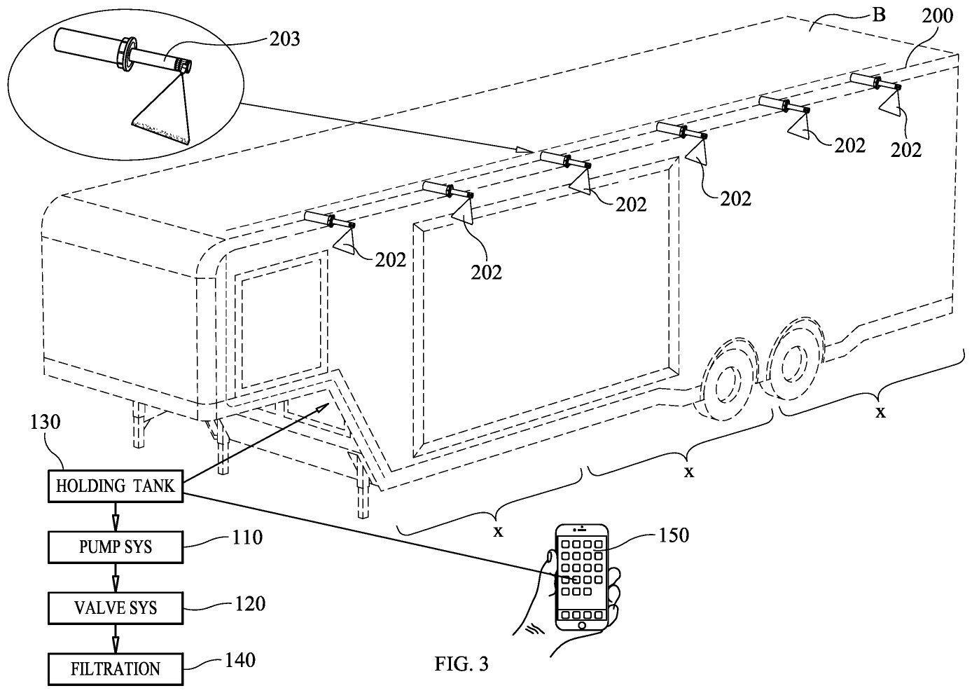

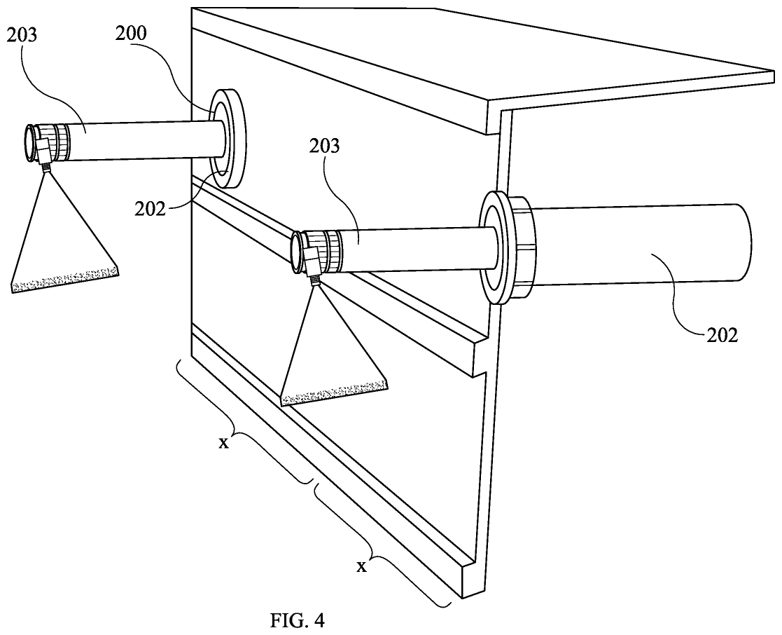

Another embodiment of the present invention as shown in FIGS. 3 and 4 is for a side mounted extrusion spray system (200) having recessed extendable nozzles (202). This embodiment is contemplated for new vehicle manufacture because of the impracticality and cost of incorporating this specific design into an existing vehicle. As this embodiment of the invention would be best suited for new vehicle manufacture, the recessed extendable nozzles (202) would have minimal interference with other roof mounted equipment typical on a large vehicle or RV. Similar to the above embodiments of the invention, the nozzles include spray heads (203) spaced at intervals along the body of a vehicle (B) wherein spray heads (203) can target specific zones (x) along the vehicle.

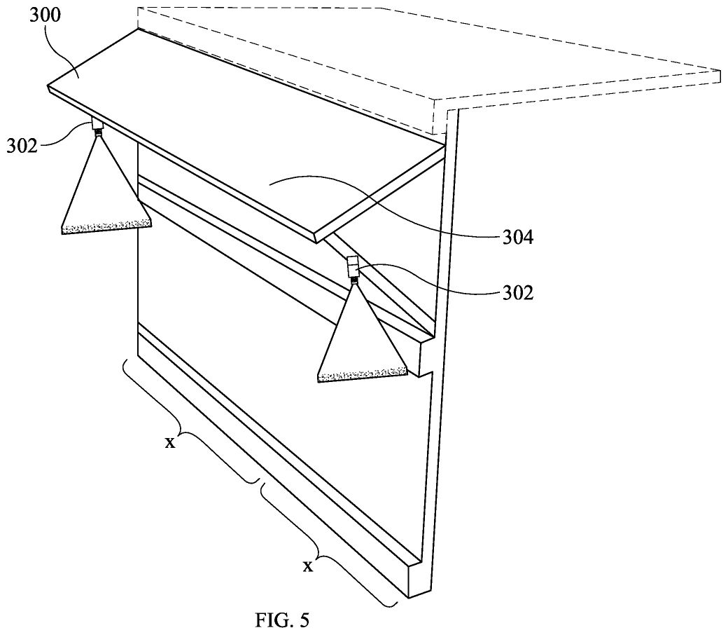

Another embodiment of the present invention intended for new vehicle installation is the extrusions profile with integrated nozzles (300) as shown in FIG. 5. In this embodiment of the invention, hinged panels (301) concealing the nozzles (302) lift outward relative to the body of the vehicle (B). The incorporated concealed nozzles (302) the achieve an unconcealed position capable of spraying the body of the vehicle (B) along various zones (x) similar to the other disclosed embodiments of the invention.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A vehicle cleaning system comprising nozzles with spray heads spaced at intervals along the length of a vehicle defining at least one specific cleaning zone along said vehicle's body, the nozzles capable of spraying water or other cleaning agents onto the body of said vehicle, said nozzles further being interconnected to each other and to a means of introducing water or cleaning agents through said system, and further comprising a valve system having at least one valve capable of turning on and off the flow of said cleaning agents defining at least one cleaning cycle;

2. The nozzles of claim 1 wherein the spray heads are contained in recessed extendable nozzles, wherein each said nozzle extends outward when the cleaning system is activated by opening at least one valve, and wherein each said nozzle is retracted into a closed position when not in use and upon turning off all said valves;

3. The nozzles of claim 2 wherein said nozzles further having rotary actuation whereby the nozzle is capable of rotating to target specific areas within the cleaning zone;

4. The means of introducing the cleaning agents of claim 1 being a hose coupling allowing for a hose line to be connected directly into said cleaning system whereby water or other cleaning agents are delivered into the vehicle cleaning system;

5. The vehicle cleaning system of claim 1 wherein said cleaning agents are stored in a holding tank located onboard said vehicle and connected to a waterline connection or electromechanical pump capable of delivering said cleaning agents through the vehicle cleaning system;

6. The vehicle cleaning system of claim 1 wherein said cleaning agents are stored apart from the vehicle's cleaning system and not onboard said vehicle, and are introduced into said vehicle cleaning system through a waterline connection or electromechanical pump means capable of delivering said cleaning agents through said vehicle cleaning system;

7. The vehicle cleaning system of claim 5 or 6 further comprising a mixing system capable of mixing water or at least one cleaning agents prior to being delivered through the vehicle cleaning system;

8. The series of valves of claim 1 being operated manually whereby different cleaning agents are introduced to the cleaning system by the switching of various valves;

9. The series of valves of claim 1 being electromechanical valves;

10. The electromechanical valves of claim 9 being connected to a computer having a motherboard, CPU, memory, and means of delivering instructions electronically to the cleaning system, wherein preprogrammed instructions delivered by the computer to turn on or off said electromechanical valves define a series automated cleaning cycles;

11. The electromechanical valves of claim 9 being connected to a computer having a motherboard, CPU, memory, NFC communication capability, and means of delivering instructions electronically to the cleaning system, whereby cleaning cycles can be activated by a computer application on an NFC device;

12. A vehicle cleaning system comprising a roof mounted actuated piping system mounted on a body of a vehicle and having nozzles with spray heads spaced at intervals along the length of said vehicle defining specific cleaning zones along a vehicle's body, the nozzles capable of spraying water or other cleaning agents onto the body of said vehicle in said zones, said piping system further being connected a means of introducing water or cleaning agents through said system, and further comprising a valve system having at least one valve capable of turning on and off the flow of said cleaning agents defining at least one cleaning cycle;

13. The actuated piping system of claim 12 having rotary actuation to target specific areas within a cleaning zone;

14. The means of introducing the cleaning agents of claim 12 being a hose coupling allowing for a hose line to be connected directly into said cleaning system whereby water of other cleaning agents are delivered into the vehicle cleaning system;

15. The vehicle cleaning system of claim 12 wherein said cleaning agents are stored apart from the vehicle's cleaning system and not onboard said vehicle, and are introduced into said vehicle cleaning system through a waterline connection or electromechanical pump means capable of delivering said cleaning agents through said vehicle cleaning system;

16. The vehicle cleaning system of claim 14 or 15 further comprising a mixing system capable of mixing water or at least one cleaning agents prior to being delivered through the vehicle cleaning system;

17. The series of valves of claim 12 being operated manually whereby different cleaning agents are introduced to the cleaning system by the switching of various valves, and wherein at least one first valve is turned on to activate a first cleaning cycle, and at least one additional valve is turned on and one valve may be turned off to activate the next cleaning cycle;

17. The series of valves of claim 12 being electromechanical valves;

18. The electromechanical valves of claim 17 being connected to a computer having a motherboard, CPU, memory, and means of delivering instructions electronically to the cleaning system, wherein preprogrammed instructions delivered by the computer to turn on or off said electromechanical valves define automated cleaning cycles;

19. The electromechanical valves of claim 17 being connected to a computer having a motherboard, CPU, memory, NFC communication capability, and means of delivering instructions electronically to the cleaning system, whereby cleaning cycles can be activated by a computer application on an NFC device;

20. The vehicle cleaning system of claim 1 or 12, wherein said vehicle cleaning system has means to connect to a holding tank and a pump for delivering water said cleaning agents into said vehicle cleaning system;

21. The vehicle cleaning system of claim 1 or 12, wherein said valves are configured to activate only certain specific nozzles for the purpose of cleaning a specific zone or range of zones along the body of a vehicle.

22. A method for introducing, spraying, or otherwise delivering cleaning agents to the body of a vehicle, wherein a series of nozzles mounted on a body of a vehicle and spaced at intervals along the length of said vehicle defining specific cleaning zones along said vehicle's body, the nozzles having spray heads capable of spraying water and other cleaning agents onto the body of a vehicle in said zones, said nozzles further being interconnected to each other and to a means of introducing water and other cleaning agents through said system; a series of valves that may be turned on and off manually or by mechanical or electromechanical means in order to control the flow of water or other said cleaning agents through the vehicle cleaning system, and wherein the operation of said series of valves being may define at least one specific cleaning cycle.
